(19) United States
(12) Patent Application Publication
(10) Pub. No.: US 2019/0005590 A1
(43) Pub. Date: Jan. 3, 2019

(54) OUTCOME DRIVEN CASE MANAGEMENT

(71) Applicant: ACCENTURE GLOBAL SOLUTIONS LIMITED, Dublin (IE)

(72) Inventors: Chung-Sheng LI, Scarsdale, NY (US); Suraj Govind JADHAV, Mumbai, IN (US); Saurabh MAHADIK, Mumbai (IN); Prakash GHATAGE, Bangalore (IN); Guanglei XIONG, Fremont, CA (US); Emmanuel MUNGUIA TAPIA, Newark, CA (US); Mohammad Jawad GHORBANI, Foster City, CA (US); Kyle JOHNSON, San Francsico, CA (US); Colin Patrick CONNORS, Campbell, CA (US); Benjamin Nathan GROSOF, Mercer Island, WA (US)

(73) Assignee: ACCENTURE GLOBAL SOLUTIONS LIMITED, Dublin (IE)

(21) Appl. No.: 15/640,223

(22) Filed: Jun. 30, 2017

(51) Int. Cl. G06Q 40/00

(52) U.S. Cl. CPC G06Q 40/12; G06Q 30/04

(57) ABSTRACT

A system for orchestrating an operation is disclosed. The system includes an case orchestration engine to identify a discrepancy in the operation, and to generate a plurality of hypotheses for resolving the discrepancy. The case orchestration engine further collects evidence pertaining to the discrepancy in the operation, evaluates each of the plurality of hypotheses based on a dialogue-driven feedback received from a user, and selects one of the plurality of hypotheses for resolving the discrepancy based on the evidence and an expected outcome of the operation. The case orchestration engine provides reasons for the discrepancy along with remedial measures for resolving the discrepancy based on the selected hypothesis, and then generates a plan for performing the operation to achieve the expected outcome based on the remedial measures.

### TECHNICAL FIELD

The present disclosure relates to case management and in particular, relates to systems and methods for outcome-driven case management.

### BACKGROUND

Generally, various aspects, such as steps, components, events, and tasks, associated with a process in an enterprise may be managed for better efficiency and ease of implementation. As is generally known, a case management system is a shared content management system that stores information pertaining to associated operations. For example, in the health care industry and the legal industry, the case management system may store and organize details pertaining to patients and clients, respectively. Such information is stored at a common location so that it is accessible by authorized staff members. The case management system may enable viewing as well as instant retrieval of any document related to a specific case.

While helping to centralize the information, existing case management systems operate in a passive and reactive mode. Therefore, the existing case management systems may not gather resources and remove hurdles in the operation in real-time. Further, in case of an anomaly or discrepancy in the process, the conventional approach may not be able to adapt to the anomaly, thereby halting the process. This, in turn, may adversely affect an outcome of the process. For example, in case of a process pertaining to the manufacturing of an article, the way the article is manufactured may be affected due to non-resolution of the anomaly in time.

### BRIEF DESCRIPTION OF THE DRAWINGS

Features of the present disclosure are illustrated by way of example and not limited in the following figure(s), in which like numerals indicate like elements, in which:

FIG. 1 illustrates a block diagram of a system, according to an example embodiment of the present disclosure;

FIG. 2 illustrates another block diagram of the system, according to an example embodiment of the present disclosure;

FIG. 3 illustrates another block diagram of the system, according to an example embodiment of the present disclosure;

FIG. 4 illustrates a block diagram depicting a dialogue-driven interaction of the system with a user, according to an example embodiment of the present disclosure;

FIG. 5 illustrates a hardware platform for implementation of the system, according to an example of the present disclosure;

FIG. 6 illustrates a flowchart depicting a computer-implemented method for orchestration of an operation, according to an example embodiment of the present disclosure;

FIG. 7 illustrates a flowchart depicting a computer-implemented method for orchestration of an operation, when the operation is one of a reconciliation operation, a matching operation, a payment collection operation, and a billing operation, according to an example embodiment of the present disclosure; and

FIG. 8 illustrates a flowchart depicting a computer-implemented method for orchestration of an operation in case of a dispute, according to an example embodiment of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures readily understood by one of ordinary skill in the art have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

The present subject matter describes systems and methods for outcome driven case management operations. Although the overview is explained with respect to one of the systems of the present disclosure, the overview is equally applicable to the other system and the method, without departing from the scope of the present disclosure.

In an example embodiment, the operation may include, but is not limited to, a reconciliation operation, a matching operation, an invoice generation operation, a payment collection operation, a dispute resolution operation, and a billing operation. The system may identify a discrepancy in the operation, based on one or more predefined operation-specific parameters. For example, in case of the operation being the reconciliation operation, the predefined operation-specific parameters may include, but are not limited to, operators for determining matching of different values and a matching table indicating matching or un-matching of the values.

The system may generate a plurality of hypotheses for resolving the discrepancy. A hypothesis is indicative of a potential reason for occurrence of the discrepancy in the operation. Upon generation of the plurality of hypotheses, the system may investigate details pertaining to the operation in order to collect evidence related to the discrepancy. Furthermore, the system may evaluate each of the plurality of hypotheses, based on a dialogue-driven feedback received from a user. The system may interact with the user in order to gather information for evaluating each hypothesis. The system may interact in a dialogue-driven manner, i.e., the system may guide the interaction in order to achieve the requisite information from the user.

Based on the evidence, the information gathered from the user, and an expected outcome of the operation, the system may select one of the pluralities of hypotheses for resolving the discrepancy. Furthermore, on the basis of the selected hypothesis, the system may provide reasons for the discrepancy along with remedial measures for resolving the discrepancy. The system may then generate a plan for performing the operation to achieve the expected outcome, based on the remedial measures. The system may also measure the performance of a process based on an execution of the generated plan. In addition, the system may automatically adjust the process based on the measured performance.

The present disclosure offers a comprehensive approach for managing a case based on the desired outcome. The system is implementable in a variety of applications as mentioned above. Further, the management of the case is outcome-driven, i.e., the operation may be modified based on an outcome of the operation. Therefore, the case management as performed by the system becomes adaptable and scalable.

Also, since the case management is outcome-driven, even in case of a discrepancy, the system ensures that a plan to perform one or more operations with the case management system gets updated in order to achieve the predefined outcome. Therefore, irrespective of the discrepancies, the outcome of the operation remains unchanged as the plan is updated in real-time. In addition, the system proactively identifies the discrepancy and generates the hypothesis for the resolution by either fixing or avoiding the discrepancy. Therefore, the system offers flexibility of operation and ensures that the operation is not halted. One of ordinary skill in the art will appreciate that the present disclosure offers a comprehensive, flexible, accurate, effective, intelligent, and proactive approach for managing a case based on a desired outcome.

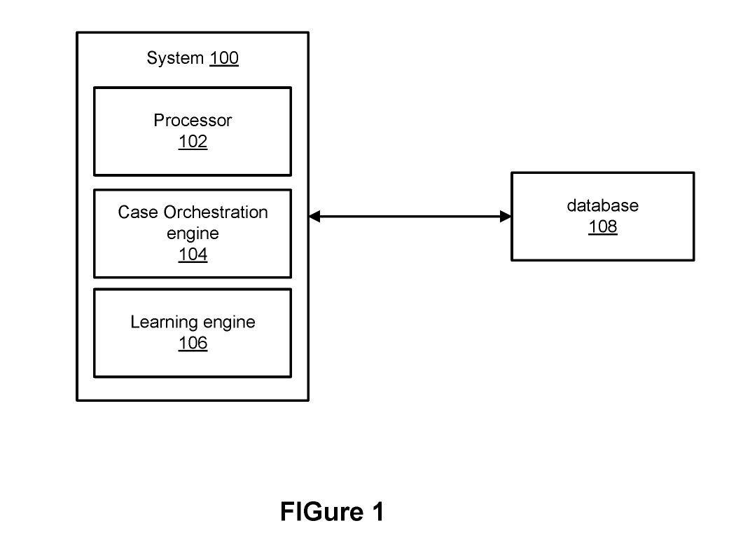

FIG. 1 illustrates a block diagram of a system 100 for orchestrating activities in a case management system based on a desired outcome, according to an example embodiment of the present disclosure. The operations to be managed may relate to various domains of an enterprise, such as manufacturing, production, human resources, and accounting. In an example embodiment, the system 100 may perform the orchestration for a case management system that may be implemented in a healthcare or legal organization. In an example embodiment, the operation may include, but is not limited to, a reconciliation operation, a matching operation, an invoice generation operation, a payment collection operation, a dispute resolution operation, and a billing operation.

As may be understood, the system 100 may be implemented for orchestrating a single operation or a plurality of operations in a case management system. The plurality of operations may be implemented by a single enterprise or, in certain examples, may be implemented by more than one enterprise/organization. For the sake of brevity, the following description has been explained with reference to a single operation. However, it will be appreciated that similar principles may be extended to other examples, where multiple operations or a process spanning across multiple enterprises are to be orchestrated.

In an example embodiment, the system 100 may include a processor 102, a case orchestration engine 104, and a learning engine 106. The processor 102, the case orchestration engine 104, and the learning engine 106 may be in communication with each other.

The case orchestration engine 104 or the learning engine 106 may be implemented as, signal processor(s), state machine(s), and/or logic circuitries. Further, the case orchestration engine 104 or the learning engine 106 can be implemented in hardware, instructions executed by a processing unit, or by a combination thereof. The processing unit can comprise a computer, a processor, a state machine, a logic array or any other suitable devices capable of processing instructions. The processing unit can be a specialized processor, which executes instructions to perform the required tasks.

In another aspect of the present disclosure, the case orchestration engine 104 or the learning engine 106 may be machine-readable instructions (software) which, when executed by a processor/processing unit, perform any of the described functionalities. The machine-readable instructions may be stored on an electronic memory device, hard disk, optical disk or other machine-readable storage medium or non-transitory medium.

The case orchestration engine 104 may receive details pertaining to an operation in the case management system. The case orchestration engine 104 may identify a discrepancy in the details of the operation, based on one or more predefined operation-specific parameters. Upon identification of the discrepancy, the case orchestration engine 104 may classify the discrepancy into one or more of predefined classes of discrepancies pertaining to the operation.

Based on the classification, the case orchestration engine 104 may generate a plurality of hypotheses for resolving the discrepancy. A hypothesis is indicative of a potential reason for occurrence of the discrepancy. In an example embodiment, the case orchestration engine 104 may generate the plurality of hypotheses, based on machine learning techniques. Furthermore, the case orchestration engine 104 may investigate the details and then collect evidence pertaining to the discrepancy in the operation, based on the investigation. In an example embodiment, the case orchestration engine 104 may investigate the details pertaining to the operation, based on a predefined set of rules and policies.

In an example embodiment, the case orchestration engine 104 may determine a possibility of each of the plurality of hypotheses for providing a reason of the discrepancy. In addition, the case orchestration engine 104 may evaluate each of the plurality of hypotheses, based on a dialogue-driven feedback received from a user. In an example embodiment, the system 100 may interact with the user for receiving the feedback. In an example embodiment, the case orchestration engine 104 may interact with the user for receiving the dialogue-driven feedback through at least one of a Natural Language Generation (NLP) technique, a Natural Language Understanding (NLU) technique, an Automatic Speech Recognition (ACR) technique, and a Text-To-Speech (TTS) synthesis technique.

Based on the evidence and an expected outcome of the operation, the case orchestration engine 104 may select one of the pluralities of hypotheses for resolving the discrepancy. Following the selection, the case orchestration engine 104 may generate a confidence score for the selected hypothesis. The confidence score is indicative of an accuracy of the selection of the hypothesis. Additionally, based on the confidence score, the case orchestration engine 104 may provide reasons for the discrepancy along with remedial measures for resolving the discrepancy.

In an example embodiment, a threshold value of the confidence score may be defined for orchestration of the operation. In an example embodiment, the confidence score may be above the threshold value. In such an example embodiment, the case orchestration engine 104 may provide the reasons for the discrepancy along with the remedial measures based on the selected hypothesis.

In an alternative example embodiment, the confidence score may be less than the threshold value. In such an example embodiment, the case orchestration engine 104 may provide the reasons for the discrepancy along with the remedial measures based on a user feedback. The case orchestration engine 104 may generate a plan for performing the operation to achieve the expected outcome, based on the remedial measures.

In addition, the case orchestration engine may measure performance of a process based on an execution of the generated plan and automatically adjust the process based on the measured performance. For example, the system 100 may be implemented as a case management subsystem in a parts ordering environment. Specifically, the case orchestration engine 104 may generate a plan to order parts from multiple vendors. Upon execution of the plan, the case orchestration engine 104 may receive details about the parts ordered from multiple wholesalers. These details may include, for example, the whole sale cost for the parts ordered from the separate vendors. The case orchestration engine 104 may also receive details about the retail cost at which the parts from the different vendors are sold. The case orchestration engine 104 may determine the profit margin by calculating the difference between the wholesale cost and retail cost of the parts ordered from different vendors. If for parts ordered from certain vendors, the profit margin is below a predefined threshold, the case orchestration engine 104 may automatically cause the reduction or a halt in the ordering of the parts from those vendors and an automatic compensating increase of the ordering of the parts from vendors where the profit margin is at or above the predefined threshold.

The case orchestration engine 104 may effectuate the automatic change in the ordering by connecting with a part ordering tool such as an Enterprise Resource Planning (“ERP”) tool and modifying order data within the tool to ensure that parts are being ordered from the more cost effective vendors.

In an example embodiment, the system 100 may be implemented in a retail store or a convenience store. In such an example embodiment, the case orchestration engine 104 may receive details pertaining to the performance of the operation, based on the plan. The details may include, but are not limited to, a number of products of a vendor sold by the retail store, a number of products of the vendor available in an inventory of the retail store, a number of products of the vendor in transit to customers, and a number of products of the vendor that is in process of return by the customers.

Based on the details, the case orchestration engine 104 may compare a cost recovered by the retail store on account of sale of the products of the vendor with a cost paid to the vendor for supply of the products to the retail store. The case orchestration engine 104 may detect an inconsistency between the cost paid to a vendor and the cost recovered by the retail store.

Further, the case orchestration engine 104 may determine a cost to be paid by the vendor to the retail store, based on the inconsistency. For example, when the cost paid to the vendor is greater than the cost recovered by the retail store, a cost may be incurred to the vendor for resolving the inconsistency. In an example embodiment, the case orchestration engine 104 may generate a report and may then forward the report to the vendor. The report may include, but is not limited to, the cost to be paid by the vendor to the retail store, a reason of the inconsistency, and a time limit for payment of the cost by the vendor.

For example, a vendor may run a campaign of selling a number of televisions at a reduced price for a predefined time duration through a retail store. An agreement may be signed between the retail store and the vendor stating that the reduction in the price of the televisions during the predefined time duration shall be observed by the vendor. After the completion of the predefined time duration, the case orchestration engine 104 may conduct a post-payment audit operation as mentioned above. The case orchestration engine 104 may retrieve details pertaining to the performance of the operation, that is, the sale of the products of the vendor by the retail store. The operation may broadly be identified as one of the invoice generation operation, the payment collection operation, the dispute resolution operation, and the billing operation. In an example embodiment, the case orchestration engine 104 may retrieve details pertaining to emails reflecting negotiation of the retail store and the vendor with regard to the reduction in the price. Further, the case orchestration engine 104 may retrieve the details pertaining to the sale of the products as explained above. Based on the retrieved details, the orchestration engine 104 may compare the cost paid to the vendor and the cost recovered by the retail store. Accordingly, the case orchestration engine 104 may generate the report and forward the report to the vendor.

In an example embodiment, the learning engine 106 may store details pertaining to at least one of identification of the discrepancy, generation and evaluation of the plurality of hypotheses, selection of one of the plurality of hypotheses, and generation of the plan. In an example embodiment, the learning engine 106 may store the details in a database 108. The database 108 may be an internal database, an external database or any combination thereof.

Once the learning engine 106 stores the details, the case orchestration engine 104 may receive the stored details from the learning engine 106. Furthermore, in case of subsequent identification of discrepancies, the case orchestration engine 104 may orchestrate the operation, based on the stored details.

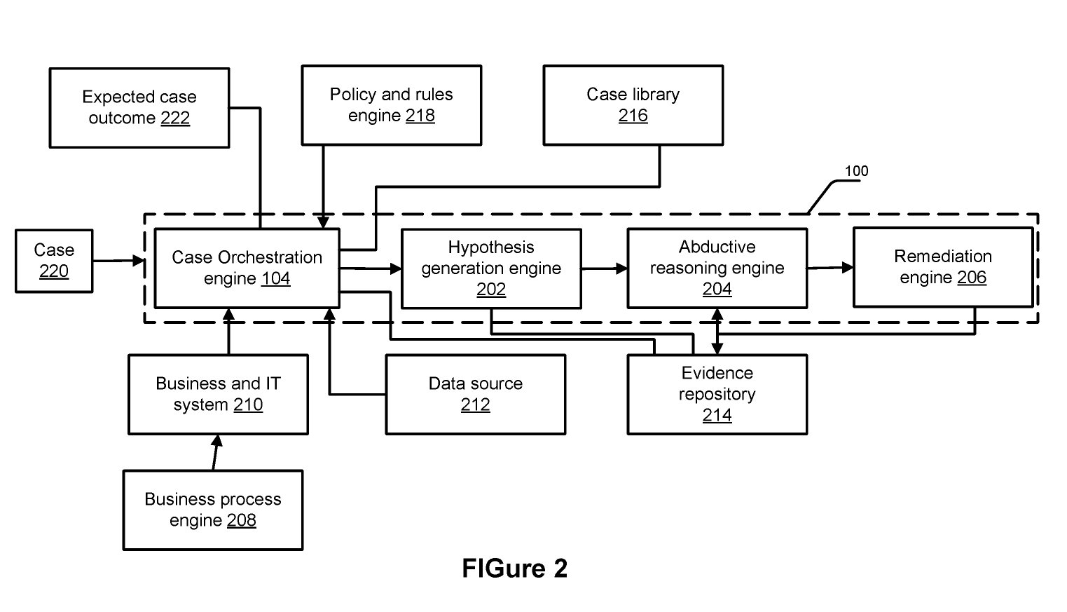

FIG. 2 illustrates another block diagram of the system 100, according to an example embodiment of the present disclosure. In an example embodiment, the system 100 may include other components as well and may allocate some of the functionalities of the case orchestration engine 104 to such other components. For the sake of brevity, features of the system 100 that are already explained in the description of FIG. 1 are not explained in detail in the description of FIG. 2.

In the present example embodiment, the system 100 may include the case orchestration engine 104, a hypothesis generation engine 202, an abductive reasoning engine 204, and a remediation engine 206. The case orchestration engine 104, the hypothesis generation engine 202, the abductive reasoning engine 204, and the remediation engine 206 may be in communication with each other. The system 100 may be in communication with a business process engine 208, a business and Information Technology (IT) system 210, a data source 212, an evidence repository 214, a case library 216, and a policy and rule engine 218.

In an example embodiment, the case orchestration engine 104 may receive a discrepancy, also referred to as a case 220. The case 220 may be generated in the business process engine 208 and may be forwarded to the case orchestration engine 104 through the business and IT system 210. The business and IT system 210 may trigger the progression of the case 220 towards the case orchestration engine 104. For example, in case of the operation being related to billing and collection, a bill may be generated and forwarded to a client. In such a case, the trigger of the case 220 may be the client being unhappy about an amount mentioned in the bill. Therefore, the business and IT system 210 may trigger the case 220 based on the client dissatisfaction. The client dissatisfaction may be understood as an event which may then be forwarded from the business and IT system 210 to the case orchestration engine 104.

In an example embodiment, the case orchestration engine 104 may receive an expected case outcome 222 as well. In one example embodiment, the expected case outcome 222 may be to resolve the case 220. For example, in case of invoice generation, the expected case outcome 222 may be to generate an invoice, which is, detailed enough for the concerned parties to conveniently understand.

In an example embodiment, the case orchestration engine 104 may receive the details pertaining to an operation such as, for example, the dispute resolution operation or the invoice generation operation, from the data source 212. Thereafter, the case orchestration engine 104 may process the event, the structured data and unstructured data for orchestration of the operation. In an example embodiment, the case orchestration engine 104 may orchestrate the operation, based on a set of policies and rules received from the policy and rules engine 218. The set of policies and rules may be understood as constraints or compliance norms for performing the orchestration of the operation. For example, one of the rules may be not to invade somebody's privacy while investigating for the evidence. The case orchestration engine 104 may investigate the details of the operation to determine the evidence for resolving the case 220. In an example embodiment, the case orchestration engine 104 may store the evidence in the evidence repository 214. The evidence repository 214 may also be in communication with the hypothesis generation engine 202, the abductive reasoning engine 204, and the remediation engine 206.

The hypothesis generation engine 202 may generate the plurality of hypotheses, based on the evidence. In an example embodiment, the abductive reasoning engine 204 may identify or evaluate one of the pluralities of hypothesis, based on the evidence and the expected case outcome 222.

Furthermore, the remediation engine 206 may provide reasons for generation of the case 220 and corresponding remedial measure for closing or resolving the case 220. In an example embodiment, the remediation engine 206 may forward the reasons and the remedial measures of each case 220 to the case library 216, which is in communication with the case orchestration engine 104.

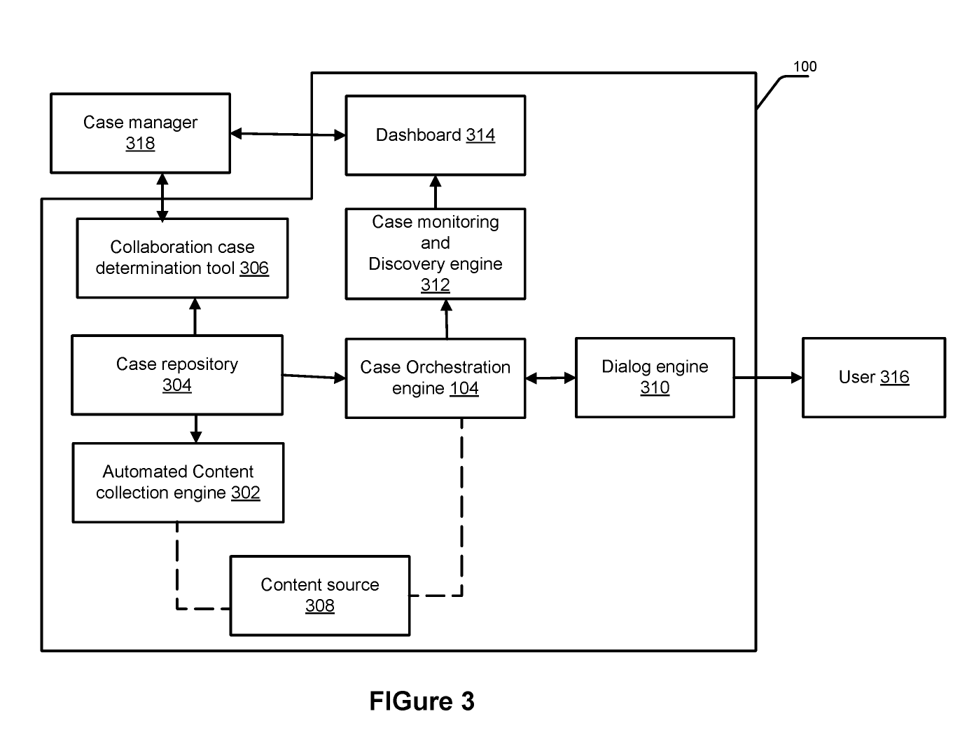

FIG. 3 illustrates another block diagram of the system 100, according to an example embodiment of the present disclosure. For the sake of brevity, features of the system 100 that are already explained in the description of FIG. 1 and FIG. 2 are not explained in detail in the description of FIG. 3.

In the present example embodiment, the system 100 may include an automated content collection engine 302, a case definition repository 304, a collaborative case definition tool 306, a content source 308, the case orchestration engine 104, a dialogue engine 310, a case monitoring and discovery engine 312, and a dashboard 314. In an example embodiment, the automated content collection engine 302, the case definition repository 304, the collaborative case definition tool 306, the content source 308, the case orchestration engine 104, the dialogue engine 310, the case monitoring and discovery engine 312, and the dashboard 314 may be in communication with each other.

In an example embodiment, the automated content collection engine 302 may receive an investigation event. An investigation event may be understood as a report of investigation of the details of the operation. Further, the automatic content collection engine 302 may identify a case, based on the investigation event. In an example embodiment, the automatic content collection engine 302 may retrieve a definition of the identified case from the case definition repository 304. The case definition repository may collect potentially new cases either from an external source or from an internal source. The content definition repository 304 may be updated periodically by a case manager 318 through the collaborative case definition tool 306. In an example embodiment, the case manager 318 may define and curate the case.

In an example embodiment, the automated content collection engine 302 may receive the details pertaining to the case from the content source 308. The content source 308 may be in communication with the case orchestration engine 104 as well. In an example, the content source 308 may be an internal database or an external database.

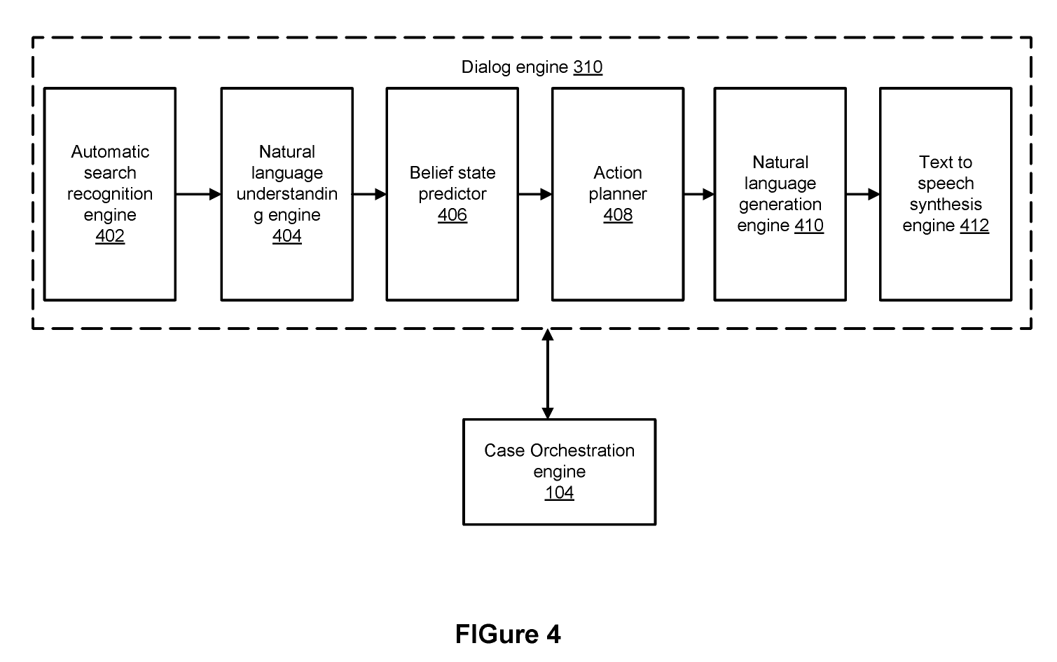

Additionally, in the case orchestration engine 104, activities pertaining to resolving or closing of the case may be performed. The case orchestration engine 104 may be in communication with the dialogue engine 310 which may further be in communication with a user 316. In an example embodiment, the case orchestration engine 104 may perform the activities based on a dialogue-driven interaction performed by the dialogue engine 310 with the user 316. The features of the dialogue engine 310 are explained in detail in description of FIG. 4.

Further, the case monitoring and discovery engine 312 may monitor and store activities pertaining to the case management performed by the system 100. For example, the case monitoring and discovery engine 312 may develop patterns of execution for analysis. In an example embodiment, the case manager 318 may access the functionalities of the system 100 through the dashboard 314.

FIG. 4 illustrates a block diagram depicting the components of the dialogue engine 310, according to an example embodiment of the present disclosure. For the sake of brevity, features of the system 100 that are already explained in the description of FIG. 1, FIG. 2, and FIG. 3 are not explained in detail in the description of FIG. 4.

In an example embodiment the system 100 may implement the dialog engine 310 for extracting operation and personnel information. The dialog engine 310 may interact with one or more users for obtaining the aforementioned information.

The dialogue engine 310 may include an Automatic Speech Recognition (ASR) engine 402, a Natural Language Understanding (NLU) engine 404, a belief state predictor 406, an action planner 408, a Natural Language Generation (NLG) engine 410, and a Text-To-Speech (TTS) synthesis engine 412. The ASR engine 402, the NLU engine 404, the belief state predictor 406, the action planner 408, the NLG engine 410, and the TTS synthesis engine 412 may be in communication with each other.

The ASR engine 402 may detect speech of the user for collecting the information from the user. The NLU engine 404 may understand intent of a discussion or interaction with the user. Further, the belief state predictor 406 may predict a direction of the interaction with user, based on a current state of the interaction and input of the user. The belief state predictor 406 may predict questions that can be asked by the user. The belief state predictor 406 may lead the conversation based on information to be retrieved from the user.

Further, the action planner 408 may plan to guide the interaction with the user towards a desired outcome. The action planner 408 may be in communication with the NLG engine 412 to determine the actual natural language to be generated to interact with the user. In an example embodiment, the dialogue engine 310 may interact with the user through speech, emails, or chats. The TTS synthesis engine 414 may assist in converting the text into speech. Additionally, the case orchestration engine 104 may be in communication with the action planner 408 of the dialogue engine 310.

In an example embodiment, the dialogue engine 310 may implement at least one of a speech recognition technique, an image analysis technique, a video analysis technique, and a natural language processing technique for collecting the unstructured data, such as speech, image, video, and text in the process information. The image analysis technique and the video analysis technique may include techniques for recognizing images/videos and understanding the recognized images/videos.

Therefore, the dialogue engine 310 may control the flow of the interaction with user. The dialogue engine 310 may gather information from the user, may communication with an external application, and may communicate information to the user.

In an example embodiment, the dialogue engine 310 may design a dialogue model for interacting with the user by developing a frame having slots. In case of a reconciliation operation, the frame may have three slots, a first slot for an unmatched item on a left side of a panel, a second slot for another unmatched item on a right side of the panel, and a third slot for a new entity to be generated for matching the unmatched items.

The dialogue engine 310 may guide the conversation with the user for collecting the requisite information. In the present example, the dialogue engine 310 may guide the conversation to gather the information for the third slot so that the unmatched entities can be matched, and the corresponding case can be closed.

In an example, the operation may be an invoice generation operation. In such an example, an invoice is generated and a case is subsequently opened for collection of payment against the invoice. There may be a plurality of possible stages of payment, such as “payment overdue” and “payment dispute”. The expected case outcome is collection of the payment.

The customer may express dissatisfaction with regard to the amount reflected in the invoice. The system 100 may investigate details pertaining to the invoice. In an example embodiment, when the system 100 may determine that the invoice is incorrect, the system 100 may revise and resend the invoice to the customer. The case can still not be closed as the payment has not been collected yet. In another example embodiment, when the system 100 may determine that the invoice is correct and the dispute may not have any merit, the system 100 may notify the customer for pending payment, after predefined time intervals. In some cases, the system 100 may interact with the customer to resolve the issue.

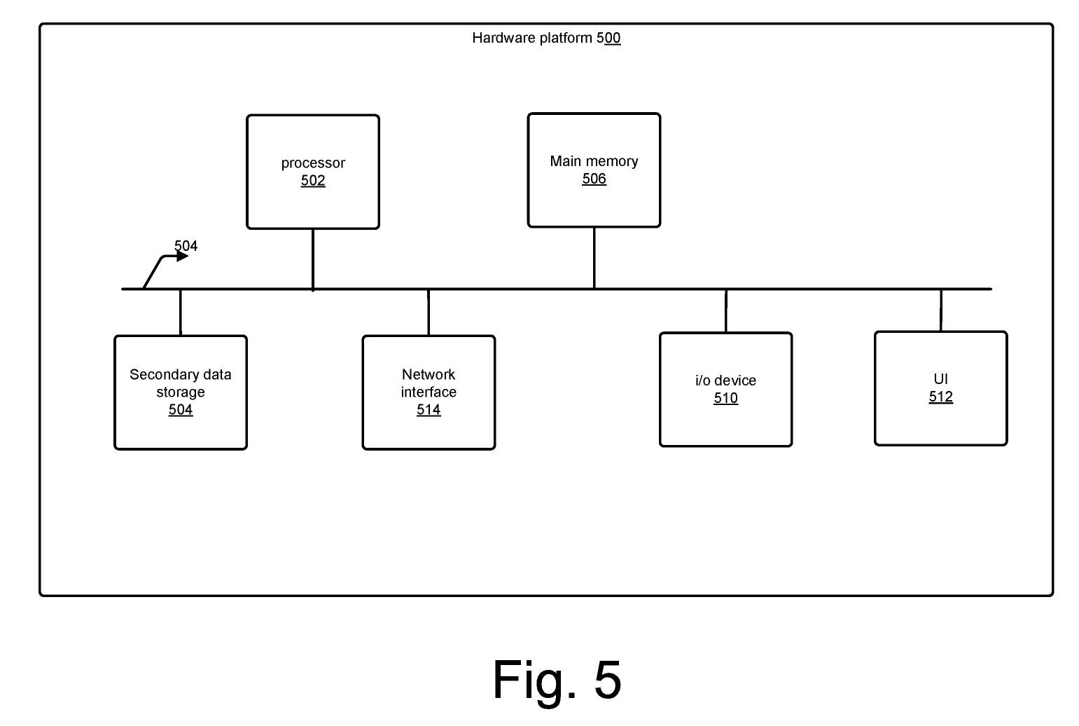

FIG. 5 illustrates a hardware platform 500 for implementation of the system 100, according to an example of the present disclosure. In an example embodiment, the hardware platform 500 may be a computer system 500 for implementing the system 100 that may be used with the examples described herein. The computer system 500 may represent a computational platform that includes components that may be in a server or another computer system. The computer system 500 may execute, by a processor (e.g., a single or multiple processors) or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 500 may include a processor 502 that may implement or execute machine-readable instructions performing some or all of the methods, functions, techniques and/or other processes described herein. Commands and data from the processor 502 may be communicated over a communication bus 504. The computer system 500 may also include a main memory 506, such as a random access memory (RAM), where the machine readable instructions and data for the processor 502 may reside during runtime, and a secondary data storage 508, which may be non-volatile and stores machine readable instructions and data. The memory 506 and the data storage 508 are examples of non-transitory computer readable mediums. The memory 506 and/or the secondary data storage may store data used by the system 100, such as an object repository including web objects, configuration data, test data, etc.

The computer system 500 may include an Input/Output (I/O) device 510, such as a keyboard, a mouse, a display, etc. A user interface (UI) 512 can be a communication device that provides textual and graphical user interfaces to a user of the system 100. The UI 512 may operate with I/O device 510 to accept from and provide data to a user. The computer system 500 may include a network interface 514 for connecting to a network. Other known electronic components may be added or substituted in the computer system 500. The processor 502 may be designated as a hardware processor. The processor 502 may execute various components of the system 100 described above and perform the methods described below.

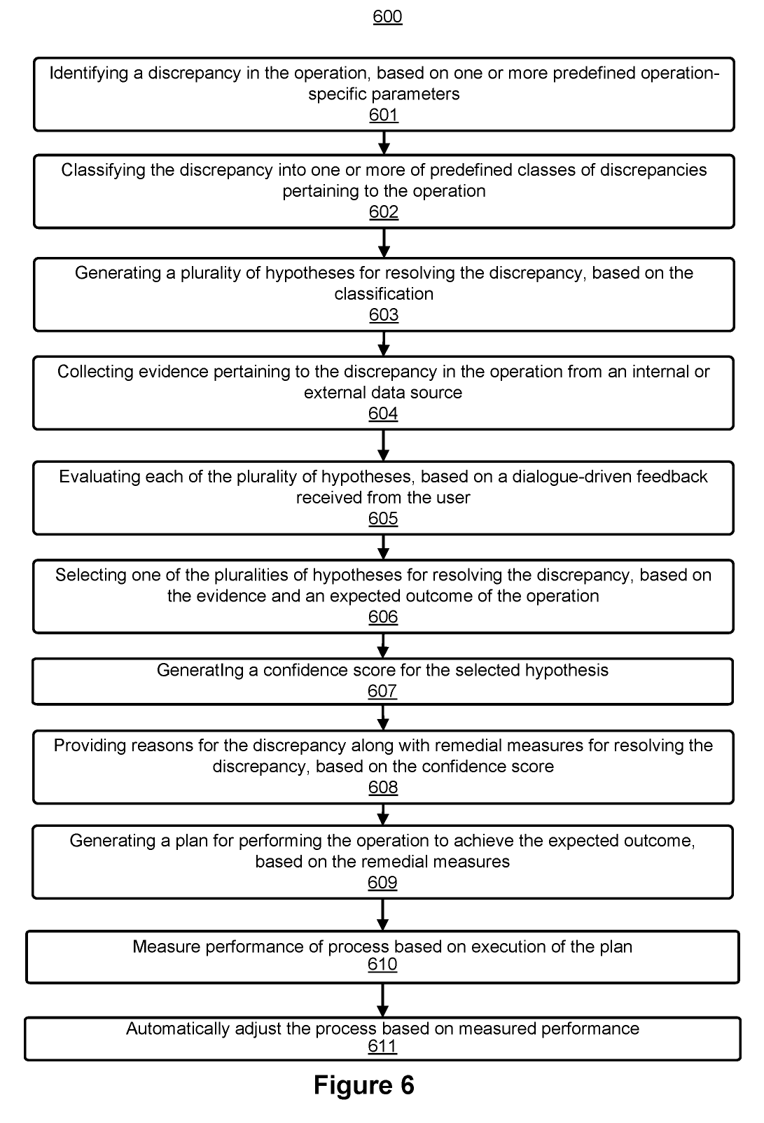

FIG. 6 illustrates a flowchart depicting a computer-implemented method 600 for orchestration of an operation, according to an example embodiment of the present disclosure. The method 600 may be performed by one or more servers or other types of computers including at least one processor executing machine-readable instructions embodying the methods. For example, the system 100 illustrated in FIG. 1 may store machine-readable instructions embodying the method 600, and the processor 102 may execute the machine-readable instructions. The method 600 is described by way of an example as being performed by the system 100. For the sake of brevity, features of the system 100 that are already explained in the description of FIG. 1, FIG. 2, FIG. 3, FIG. 4, and FIG. 5 are not explained in detail in the description of FIG. 6.

At 601, the method 600 may commence with identifying a discrepancy in the operation, based on one or more predefined operation-specific parameters. The operation may include, but is not limited to, a reconciliation operation, a matching operation, an invoice generation operation, a payment collection operation, a dispute resolution operation, or a billing operation.

At 602, the discrepancy may be classified into one or more of predefined classes of discrepancies pertaining to the operation. At 603, a plurality of hypotheses may be generated for resolving the discrepancy, based on the classification. Each hypothesis is indicative of a potential reason for occurrence of the discrepancy.

At 604, the method 600 may include collecting evidence pertaining to the discrepancy in the operation from an internal or external data source, based on an investigation of details pertaining to the operation. At 605, each of the plurality of hypotheses may be evaluated, based on a dialogue-driven feedback received from the user.

At 606, one of the pluralities of hypotheses may be selected for resolving the discrepancy, based on the evidence and an expected outcome of the operation. At 607, a confidence score may be generated for the selected hypothesis. The confidence score is indicative of an accuracy of the selection of the hypothesis.

At 608, reasons for the discrepancy along with remedial measures for resolving the discrepancy may be provided based on the confidence score. In an example embodiment, the method 600 may include providing the reasons for the discrepancy along with the remedial measures based on the selected hypothesis, when the confidence score is above a threshold value for the confidence score. In an alternative example embodiment, the method 600 may include providing the reasons for the discrepancy along with the remedial measures based on a user feedback, when the confidence score is below a threshold value for the confidence score.

At 609, a plan may be generated for performing the operation to achieve the expected outcome, based on the remedial measures. In an example embodiment, the method 600 may include storing details pertaining to at least one of identification of the discrepancy, generation and evaluation of the plurality of hypotheses, selection of one of the plurality of hypotheses, and generation of the plan. Further, in case of subsequent identification of discrepancies, the operation may be orchestrated based on the stored details.

At 610, the performance of a process based on the execution of the generated plan may be measured. At 611, the process may be automatically adjusted based on the measured performance.

In an example embodiment, after generation of the plan, the method 600 may include receiving details pertaining to the performance of the operation. The details may include, but are not limited to, a number of products of the vendor sold by the retail store, a number of products of the vendor available in an inventory of the retail store, a number of products of the vendor in transit to the customers, and a number of products of the vendor that is in process of return by the customers. Further, an inconsistency between a cost paid to a vendor for supply of the products to the retail store and a cost recovered by the retail store on account of sale of the products of the vendor may detected based on a comparison. The method 600 may further include determining a cost to be paid by the vendor to the retail store, based on the inconsistency. A report may then be generated and forwarded to the vendor. The report may include, but is not limited to, the cost to be paid by the vendor to the retail store, a reason of the inconsistency, and a time limit for payment of the cost by the vendor.

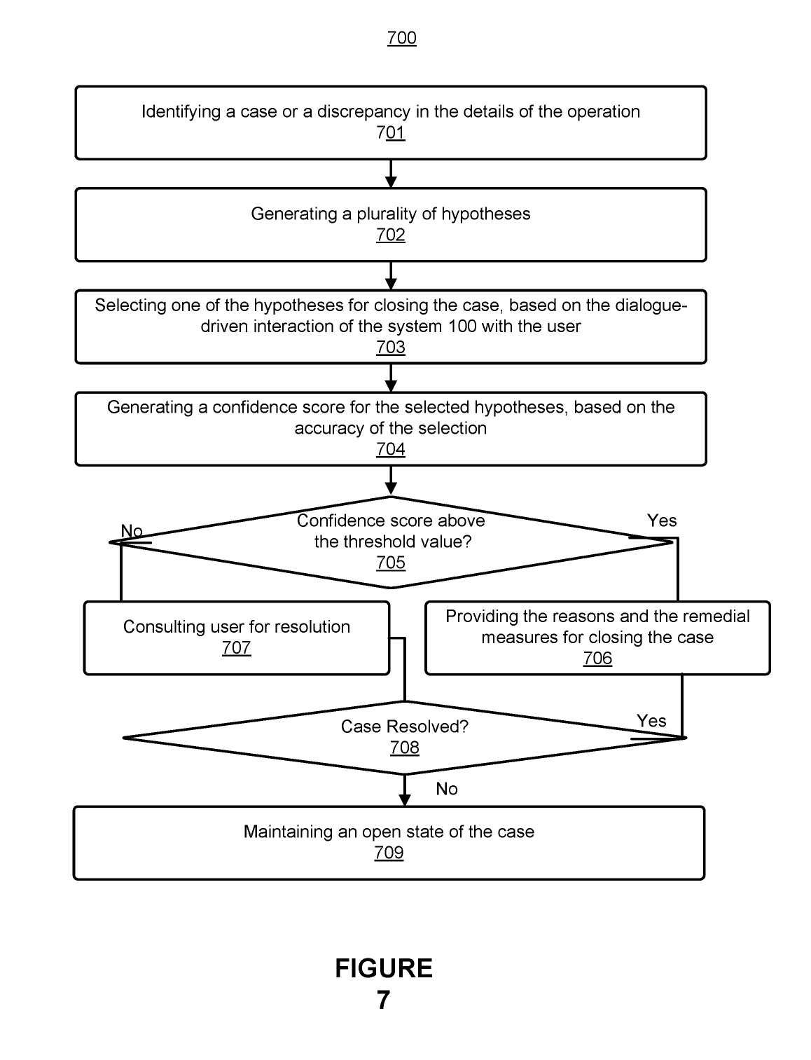

FIG. 7 illustrates a flowchart depicting a computer-implemented method 700 for case management of an operation, when the operation is one of a reconciliation operation, a matching operation, a payment collection operation, or a billing operation, according to an example embodiment of the present disclosure. For the sake of brevity, features of the system 100 that are already explained in the description of FIG. 1, FIG. 2, FIG. 3, FIG. 4, FIG. 5 and FIG. 6 are not explained in detail in the description of FIG. 7.

At 701, the method 700 may commence with identification of a case or a discrepancy in the details of the operation. In case of the reconciliation operation, the details may include, but are not limited to, a reconciliation statement from an Enterprise Resource Planning (ERP) system. In case of the matching operation, the details may include, but are not limited to, a discrepancy report. In case of the payment collection operation, the details may include, but are not limited to, details pertaining to a corresponding invoice and status of payment. In case of the billing operation, the details may include, but are not limited to details pertaining to services availed.

At 702, the method 700 may include generating the plurality of hypotheses. In case of the reconciliation operation, the plurality of hypotheses may include, but is not limited to, outstanding checks, deposits in transit, bank service charges, check printing charges, errors on books, errors by the bank, electronic charges on the bank statement not yet recorded on the books, and electronic deposits on the bank statement that are not yet recorded on the books. In case of the matching operation, the plurality of hypotheses may include, but is not limited to, freight not included in Purchase Order, sales tax calculation variation, purchase order overspent, and line item or quantity mismatch. In case of the billing operation, the plurality of hypotheses may include, but is not limited to, charge to account error, division or department or project coding error, and discrepancy between service rendered and manifest

At 703, one of the hypotheses may be selected for closing the case, based on the dialogue-driven interaction of the system 100 with the user.

At 704, the confidence score may be generated for the selected hypotheses based on the accuracy of the selection. At 705, it is determined whether the confidence score is above the threshold value. When the confidence score is above the threshold value, the method 700 branches to 706. At 706, the method 700 may include providing the reasons and the remedial measures for closing the case.

When it is determined that the confidence score is below the threshold value, the method branches to 707. At 707, the user is consulted for a resolution. At 708, it is determined whether the case is resolved. When it is determined that the case is resolved, the method 700 branches to 706. When it is determined that the case is not resolved, the case is not closed and the method branches to 709, where an open state of the case is maintained.

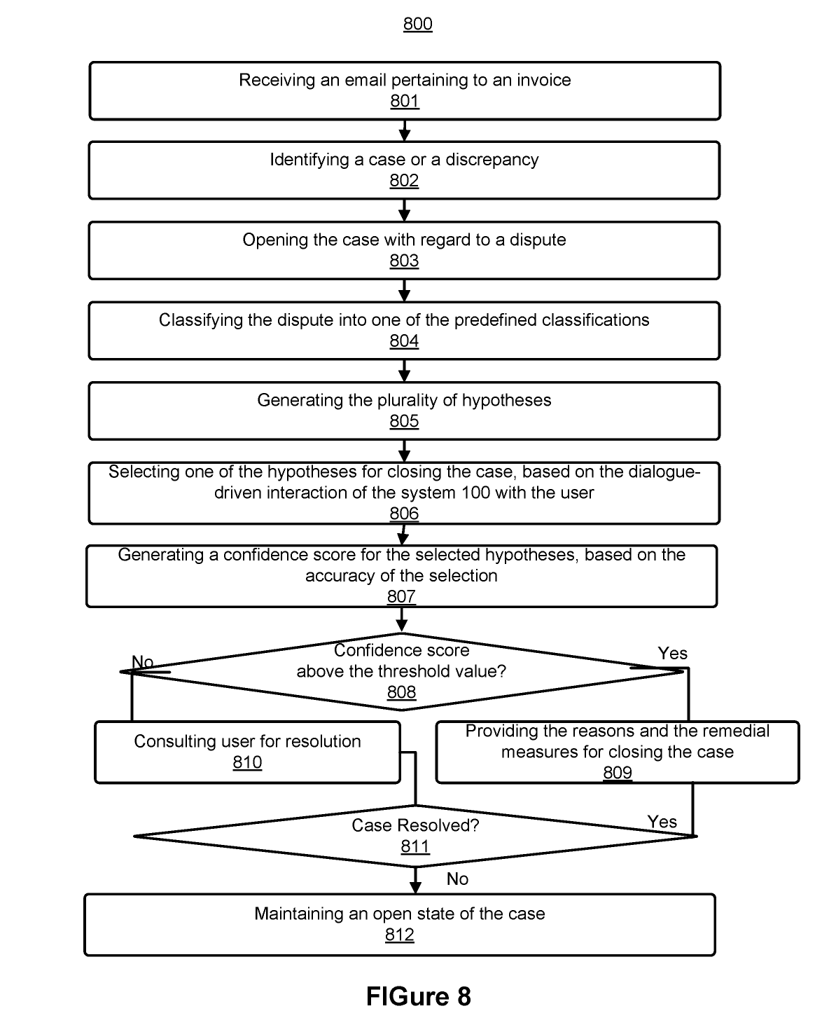

FIG. 8 illustrates a flowchart depicting a computer-implemented method for case management of an operation in case of a dispute, according to an example embodiment of the present disclosure. For the sake of brevity, features of the system 100 that are already explained in the description of FIG. 1, FIG. 2, FIG. 3, FIG. 4, FIG. 5, FIG. 6, and FIG. 7 are not explained in detail in the description of FIG. 8.

At 801, the method 800 may commence with receiving of an email pertaining to an invoice. At 802, a case or discrepancy may be identified. At 803, it is determined whether the case is classified into one of the predefined classifications. In the present example embodiment, the predefined classifications may include, but are not limited to, a query or a dispute. When it is determined that the case is a dispute, the method 800 branches to 803.

At 803, the case is opened with regard to the dispute. At 804, the dispute may be classified into one of the predefined classifications pertaining to the dispute. At 805, the method 800 may include generating the plurality of hypotheses. At 806, one of the hypotheses may be selected for closing the case, based on the dialogue-driven interaction of the system 100 with the user.

At 807, the confidence score may be generated for the selected hypotheses based on the accuracy of the selection. At 808, it is determined whether the confidence score is above the threshold value. When the confidence score is above the threshold value, the method 800 branches to 809. At 809, the method 700 may include providing the reasons and the remedial measures for closing the case.

When it is determined that the confidence score is below the threshold value, the method branches to 810. At 810, the user is consulted for resolution. At 811, it is determined whether the case is resolved. When it is determined that the case is resolved, the method 700 branches to 809. When it is determined that the case is not resolved, the case is not closed and the method branches to 812, where an open state of the case is maintained.

It should be appreciated by one or ordinary skill the art that the description of FIG. 7 and FIG. 8 is explained with regard to specific examples for the purpose of providing clarity and better understanding of the present disclosure and, therefore, should not be construed as limiting.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims and their equivalents in which all terms are meant in their broadest reasonable sense unless otherwise indicated

What is claimed is:

1. A system for case management, the system comprising:
a processor; and
a case orchestration engine coupled to the processor to:
receive details pertaining to an operation;
identify a discrepancy in details of the operation, based on one or more predefined operation-specific parameters;
classify the discrepancy into one or more of predefined classes of discrepancies pertaining to the operation;
generate a plurality of hypotheses for resolving the discrepancy, based on the classification, wherein a hypothesis is indicative of a potential reason for occurrence of the discrepancy;
collect evidence pertaining to the discrepancy in the operation, based on an investigation of the details pertaining to the operation;
evaluate the plurality of hypotheses, based on a dialogue-driven feedback received from a user;
select one of the plurality of hypotheses for resolving the discrepancy, based on the evidence and an expected outcome of the operation;
generate a confidence score for the selected hypothesis, wherein the confidence score is indicative of an accuracy of the selection of the hypothesis;
provide a reason for the discrepancy along with a remedial measure for resolving the discrepancy, based on the confidence score;
generate a plan for performing the operation to achieve the expected outcome, based on the remedial measure;
measure performance of a process based on an execution of the generated plan; and
automatically adjust the process based on the measured performance.

2. The system as claimed in claim 1, wherein the case orchestration engine is further to:
retrieve details pertaining to the performance of the operation, based on the plan, wherein the details include at least one a number of products of a vendor sold by a retail store, a number of products of the vendor available in an inventory of the retail store, a number of products of the vendor in transit to customers, and a number of products of the vendor that is in process of return by the customers;
detect an inconsistency between a cost paid to a vendor for supply of the products to the retail store and a cost recovered by the retail store on account of sale of the products of the vendor;
determine a cost to be paid by the vendor to the retail store, based on the inconsistency;
generate a report indicating at least one of the cost to be paid by the vendor to the retail store, a reason of the inconsistency, and a time limit for payment of the cost by the vendor; and
forward the report to the vendor.

3. The system as claimed in claim 1, wherein the case orchestration engine is further to provide the reason for the discrepancy along with the remedial measure based on the selected hypothesis, when the confidence score is above a threshold value for the confidence score.

4. The system as claimed in claim 1, wherein the case orchestration engine is further to provide the reason for the discrepancy along with the remedial measure based on a user feedback, when the confidence score is below a threshold value for the confidence score.

5. The system as claimed in claim 1, wherein the case orchestration engine is further to investigate the details pertaining to the operation for collecting the evidence, based on a predefined set of rules and policies.

6. The system as claimed in claim 1, wherein the case orchestration engine is further to determine a possibility of a hypothesis for providing a reason of the discrepancy.

7. The system as claimed in claim 1, wherein the case orchestration engine is further to interact with the user for receiving the dialogue-driven feedback through at least one of a Natural Language Generation (NLP) technique, a Natural Language Understanding (NLU) technique, an Automatic Speech Recognition (ASR) technique, or a Text-To-Speech (TTS) synthesis technique.

8. The system as claimed in claim 1, further comprising a learning engine in communication with the case orchestration engine to store details pertaining to at least one of identification of the discrepancy, generation and evaluation of the plurality of hypotheses, selection of one of the plurality of hypotheses, and generation of the plan.

9. The system as claimed in claim 8, wherein the case orchestration engine is further to:
receive the stored details from the learning engine; and
orchestrate the operation upon subsequent identification of discrepancies, based on the stored details.

10. A system for case management, the system comprising:
a processor; and
an case orchestration engine coupled to the processor to:
identify a discrepancy in an operation, based on one or more predefined operation-specific parameters;
generate a plurality of hypotheses for resolving the discrepancy, wherein a hypothesis is indicative of a potential reason for occurrence of the discrepancy;
collect evidence pertaining to the discrepancy in the operation, based on an investigation of details pertaining to the operation;
evaluate the plurality of hypotheses, based on a dialogue-driven feedback received from a user;
select one of the plurality of hypotheses for resolving the discrepancy, based on the evidence and an expected outcome of the operation;
provide a reason for the discrepancy along with a remedial measure for resolving the discrepancy, based on the selected hypothesis;
generate a plan for performing the operation to achieve the expected outcome, based on the remedial measure;
measure performance of a process based on an execution of the generated plan; and
automatically adjust the process based on the measured performance

11. The system as claimed in claim 10, wherein the case orchestration engine is further to:
classify the discrepancy into one or more of predefined classes of discrepancies pertaining to the operation; and
generate the plurality of hypotheses for resolving the discrepancy, based on the classification.

12. The system as claimed in claim 10, wherein the case orchestration engine is further to:
retrieve details pertaining to the performance of the operation, based on the plan, wherein the details include at least one a number of products of a vendor sold by a retail store, a number of products of the vendor available in an inventory of the retail store, a number of products of the vendor in transit to customers, and a number of products of the vendor that is in process of return by the customers;
detect an inconsistency between a cost paid to a vendor for supply of the products to the retail store and a cost recovered by the retail store on account of sale of the products of the vendor;
determine a cost to be paid by the vendor to the retail store, based on the inconsistency;
generate a report indicating at least one of the cost to be paid by the vendor to the retail store, a reason of the inconsistency, and a time limit for payment of the cost by the vendor; and
forward the report to the vendor.

13. The system as claimed in claim 10, wherein the case orchestration engine is further to generate a confidence score for the selected hypothesis, wherein the confidence score is indicative of an accuracy of the selection of the hypothesis.

14. The system as claimed in claim 11, wherein the case orchestration engine is further to provide the reason for the discrepancy along with the remedial measure based on the selected hypothesis, when the confidence score is above a threshold value for the confidence score.

15. The system as claimed in claim 11, wherein the case orchestration engine is further to provide the reason for the discrepancy along with the remedial measure based on a user feedback, when the confidence score is below a threshold value for the confidence score.

16. The system as claimed in claim 10, further comprising:
a learning engine in communication with the case orchestration engine to store details pertaining to at least one of identification of the discrepancy, generation and evaluation of the plurality of hypotheses, selection of one of the plurality of hypotheses, and generation of the plan; and
the case orchestration engine to:
receive the stored details from the learning engine; and
orchestrate the operation upon subsequent identification of discrepancies based on the stored details.

17. A computer-implemented method of case management, the method comprising:
identifying a discrepancy in an operation, based on one or more predefined operation-specific parameters;
classifying the discrepancy into one or more of predefined classes of discrepancies pertaining to the operation;
generating a plurality of hypotheses for resolving the discrepancy, based on the classification, wherein a hypothesis is indicative of a potential reason for occurrence of the discrepancy;
collecting evidence pertaining to the discrepancy in the operation from a data source, based on an investigation of details pertaining to the operation;
evaluating the plurality of hypotheses, based on a dialogue-driven feedback received from a user;
selecting one of the plurality of hypotheses for resolving the discrepancy, based on the evidence and an expected outcome of the operation;
generating a confidence score for the selected hypothesis, wherein the confidence score is indicative of an accuracy of the selection of the hypothesis;
providing a reason for the discrepancy along with a remedial measure for resolving the discrepancy, based on the confidence score;
generating a plan for performing the operation to achieve the expected outcome, based on the remedial measure;
measuring performance of a process based on an execution of the generated plan; and
automatically adjusting the process based on the measured performance.

18. The computer-implemented method as claimed in claim 17 further comprising:
retrieve details pertaining to the performance of the operation, based on the plan, wherein the details include at least one a number of products of a vendor sold by a retail store, a number of products of the vendor available in an inventory of the retail store, a number of products of the vendor in transit to customers, and a number of products of the vendor that is in process of return by the customers;
detecting an inconsistency between a cost paid to a vendor for supply of the products to the retail store and a cost recovered by the retail store on account of sale of the products of the vendor;
determining a cost to be paid by the vendor to the retail store, based on the inconsistency;
generating a report indicating at least one of the cost to be paid by the vendor to the retail store, a reason of the inconsistency, and a time limit for payment of the cost by the vendor; and
forwarding the report to the vendor.

19. The computer-implemented method as claimed in claim 17 further comprising:
providing the reason for the discrepancy along with the remedial measure based on the selected hypothesis, when the confidence score is above a threshold value for the confidence score; and
providing the reason for the discrepancy along with the remedial measure based on a user feedback, when the confidence score is below a threshold value for the confidence score.

20. The computer-implemented method as claimed in claim 17 further comprising:
storing details pertaining to at least one of identification of the discrepancy, generation and evaluation of the plurality of hypotheses, selection of one of the plurality of hypotheses, and generation of the plan; and
orchestrating the operation upon subsequent identification of discrepancies based on the stored details.
